(19) United States
(12) Patent Application Publication
(10) Pub. No.: US 2005/0116098 A1
(43) Pub. Date: Jun. 2, 2005

(54) Flight deck security system

(76) Inventors: Larry Martens, Ontario (CA); Bryan E. Markle, Ontario (CA); Hebb C. Russell, Ontario (CA)

Correspondence Address: PEARNE & GORDON LLP, 1801 EAST 9TH STREET, SUITE 1200, CLEVELAND, OH, 44114-3108, US

(21) Appl. No.: 10/500,728

(22) PCT Filed: Dec. 13, 2002
(86) PCT No.: PCT/CA02/01899

Related U.S. Application Data
(60) Provisional application No. 60/346,302, filed on Jan. 9, 2002.

(51) Int. Cl. B64D 11/00

(52) U.S. Cl. 244/118.5

(57) ABSTRACT

The present invention is directed to increasing ight deck security in support of, and in conjunction with, the new FAA mandated bullet-proof cockpit door. This is accomplished by the Crupax Flight Deck Security System (FDSS), which provides a lightweight, flexible, mechanically strong isolation curtain which is mounted in the aircraft cabin at a predetermined distance from the cockpit door to act as a physical barrier that cannot be penetrated by unauthorized persons while the cockpit door is unlocked. The curtain forms a secure zone at the cockpit door whereby a person wanting to gain entry to the flight deck will stand so that the pilot can positively identify the person as bona fide aircrew member or as a person known to him/her. The pilot will also determine that the person is alone in the secure zone. The pilots have full control of the system, and must approve each entry or exit operation.

This application claims the benefit of U.S. Provisional Patent Application Ser. No. 60/346,302 filed on Jan. 9, 2002.

### FIELD OF THE INVENTION

The invention relates generally to aircraft security and more particularly to the security of the flight deck (cockpit).

### BACKGROUND OF THE INVENTION

Recently there have been incidents involving enormous loss of life wherein suicide hijackers have commandeered jetliners and deliberately flown them into buildings, killing everyone on board as well as thousands of innocent people on the ground. In at least one case it was suspected that the hijackers took over the flight deck prior to take-off, and that a hijacker wearing a pilot's uniform was at the controls. For many years hijacking was considered more of an inconvenience than a danger, however it has taken on a new dimension with the emergence of suicide hijackers determined to use aircraft as guided bombs.

While hijacking is the most serious threat to commercial aviation, a secondary but more prevalent danger involves “air rage” incidents wherein unruly, intoxicated or deranged passengers assault flight attendants, often attempting to enter the flight deck to harass or assault the pilots.

In reaction to the hijacking events the U.S. Federal Aviation Administration mandated a new style of bullet-proof cockpit door designed to increase cockpit security. The security requirements for the cockpit door for preventing terrorists from forcefully entering the flight deck are becoming increasingly stringent, for instance the locked door must withstand up to about 500 kgf. However, even such a reinforced cockpit door will not prevent terrorists from rushing the door when it is opened to allow a member of the aircrew to enter or exit the flight deck. While the new door has made cockpit intrusion more difficult for unruly passengers, it has actually made hijacking easier and safer for the trained terrorist.

Experience has shown that terrorist hijackers do not normally force cockpit doors open, but wait until someone unlocks the door during the normal course of flight, then seize the opportunity to rush onto the flight deck and overpower the pilots. By commandeering the aircraft in this way, terrorists require no weapons but simply need to lay in wait and move quickly when the opportunity presents itself. Adding to the danger is the fact that, once flight deck entry is gained, intruders can close the cockpit door and use it to protect themselves from passengers and security personnel in the cabin. By using the new fortified door to their advantage, they are able to turn the flight deck into a fortress within which they can operate the aircraft without interference. Because of the speed and precision with which this action is executed by trained terrorists, it is apparent that no security guard or weaponry can be relied upon to stop this type of intrusion in every case.

Because the new cockpit door, standing alone, provides protection to the flight deck only when it is locked, certain airlines have taken the added precaution of installing a second door spaced from the cockpit door. The second door is to be closed so that a member of the flight crew cannot be observed entering or exiting the flight deck by the passengers and therefore terrorists would not know when to rush the door. Such an arrangement is shown schematically in U.S. patent application Publication No. US2000/0092951 published on Jul. 18, 2002. Though this arrangement may provide at least an illusion of higher security, the cost of installing a further permanent door with the accompanying wall structures in all aircraft would be prohibitive and such a permanent structure in front of the locked cockpit door in the washroom/galley area would be highly inconvenient since it would impede the legitimate movement of the aircrew and passengers in that section of the plane.

Flight deck security is no longer an option, but a serious life-and-death requirement on passenger aircraft, particularly higher capacity aircraft capable of relatively long distance flights.

Therefore, there is an urgent need for a system and a process by which intruders are prevented from accessing the flight deck of an aircraft.

### SUMMARY OF THE INVENTION

The invention is directed to an aircraft flight deck security system comprising a secure closable isolation curtain mounted in the aircraft cabin to form a barrier for entry to the flight deck when closed, a device for viewing a zone in the aircraft adjacent to the closed isolation curtain and a mechanism for closing and retracting the isolation curtain. The viewing device may be an opening in the isolation curtain or alternately a video camera in the aircraft cabin connected to a video monitor on the flight deck.

In accordance with another aspect of the invention, the aircraft flight deck security system comprises a secure closable isolation curtain adapted to be mounted in the aircraft cabin to form a secure zone outside of a lockable cockpit door to the flight deck, a unit for viewing the secure zone from the flight deck and a controller on the flight deck for controlling the operation of the isolation curtain.

In accordance with a further aspect of the invention, the aircraft flight deck security system comprises a secure closable isolation curtain mounted in the aircraft cabin to form a secure zone outside of a lockable cockpit door to the flight deck, a unit for identifying a person located in the secure zone and a controller on the flight deck for controlling the operation of the isolation curtain.

In accordance with another aspect of the invention, the person identification unit may be a biometric identification unit such as a fingerprint scanner adapted to be mounted in the secure zone and coupled to the controller. The viewing unit may be at least one video camera in the secure zone connected to a video monitor on the flight deck

In accordance with further specific aspects of the invention, the controller can be coupled to a sensor for providing the status of the lockable cockpit door and a mechanism for causing the cockpit door to unlock. The system may further include a sensor for detecting the presence of a person in a lavatory that opens into the secure zone, as well as indicators in the secure zone and on the flight deck for indicating the presence of a person in the lavatory. An electronic mechanism including an electrical motor under the control of the controller can be used to close and/or retract the curtain. Indicator lights can be mounted on or near the isolation curtain for alerting that the curtain is closing or retracting, and sensors also coupled to the controller can be mounted on a leading edge of the isolation curtain to detect any object that is in the path of the closing curtain. The curtain can also have a locking mechanism coupled to the controller means for locking the isolation curtain in the closed position.

In accordance with yet another aspect of this invention, the process under the control of a pilot for permitting entry to an aircraft flight deck where the aircraft has a lockable cockpit door to the flight deck and a lockable isolation curtain mounted to provide a secure zone in the aircraft cabin adjacent the cockpit door, comprises the steps of receiving an indication of a person's desire to enter the flight deck, verifying that the person is alone in the secure zone, closing the isolation curtain, unlocking the cockpit door, allowing the person to enter the flight deck and closing and locking the cockpit door. The curtain can be unlocked and retracted once the cockpit door is locked. If a lavatory opens into the secure zone, the occupancy of the lavatory is also verified before unlocking the cockpit door.

In accordance with a further aspect of the invention, the process under the control of a pilot for permitting aircrew entry onto an aircraft flight deck where the aircraft has a lockable cockpit door to the flight deck and a lockable isolation curtain mounted to provide a secure zone in the aircraft cabin adjacent the cockpit door, comprises receiving confirmation that the person seeking entry is a member of the aircrew, closing the isolation curtain, verifying that the person is alone in the secure zone, unlocking the cockpit door, allowing the aircrew member to enter the flight deck and closing and locking the cockpit door. The curtain can then be unlocked and retracted once the cockpit door is locked. This process can further include verifying a biometric characteristic of the person seeking entry and comparing the biometric characteristic to the biometric characteristic data of the aircrew. The biometric characteristic can be a fingerprint of the person. If a lavatory opens into the secure zone, the occupancy of the lavatory is also verified before unlocking the cockpit door.

In accordance with another aspect of the invention, the process under the control of a pilot for exiting an aircraft flight deck where the aircraft has a lockable cockpit door to the flight deck and a lockable isolation curtain mounted to provide a secure zone in the aircraft cabin adjacent the cockpit door, comprises closing and locking the isolation curtain, verifying that no one is in the secure zone, unlocking the cockpit door, exiting the flight deck and closing and locking the cockpit door. The curtain can then be unlocked and retracted once the cockpit door is locked. If a lavatory opens into the secure zone, the occupancy of the lavatory is also verified before unlocking the cockpit door. If the person exiting the flight deck wishes to use the lavatory, the person may do so without closing and locking the cockpit door, as long as the person returns to the flight deck.

In accordance with yet another aspect of the invention, the system under the control of a pilot for permitting entry to an aircraft flight deck where the aircraft has a lockable cockpit door to the flight deck and a lockable isolation curtain mounted to provide a secure zone in the aircraft cabin adjacent the cockpit door, comprises a device for providing the pilot an indication of a person's desire to enter the flight deck, a unit for verifying that the person is alone in the secure zone, a mechanism for closing the isolation curtain, and a mechanism for unlocking the cockpit door to allow the person to enter the flight deck and then for closing and locking the cockpit door. The system can further include a sensor for determining the occupancy of a lavatory that opens onto the secure zone.

In accordance with a further aspect of the invention, the system under the control of a pilot for permitting aircrew entry to an aircraft flight deck where the aircraft has a lockable cockpit door to the flight deck and a lockable isolation curtain mounted to provide a secure zone in the aircraft cabin adjacent the cockpit door, comprises a unit for providing the pilot confirmation that the person seeking entry is a member of the aircrew, a mechanism for closing the isolation curtain, a unit for verifying that the person is alone in the secure zone, and a mechanism for unlocking the cockpit door to allow the aircrew member to enter the flight deck and then for closing and locking the cockpit door. The unit for providing the pilot an indication that the person seeking entry is a member of the aircrew can include a sensor for determining the occupancy of a lavatory that opens onto the secure zone. The system may further include an identification unit for verifying a biometric characteristic of the person seeking entry and for comparing the biometric characteristic to the biometric characteristic data of the aircrew. The biometric characteristic can be the person's fingerprint.

In accordance with another aspect of the invention, the system under the control of a pilot for a person to exit an aircraft flight deck where the aircraft has a lockable cockpit door to the flight deck and a lockable isolation curtain mounted to provide a secure zone in the aircraft cabin adjacent the cockpit door, comprises a mechanism for closing and locking the isolation curtain as well as for unlocking and retracting the curtain, a unit for verifying that no one is in the secure zone, a mechanism for unlocking the cockpit door for the person to exit the flight deck and for closing and locking the cockpit door. The system can further include a sensor for determining the occupancy of a lavatory that opens onto the secure zone.

In accordance with yet another aspect of this invention, the secure isolation curtain for an aircraft comprises a flexible mechanically strong sheet material having a top, a bottom and two sides, a first track adapted to be fixed to the aircraft ceiling, a second track adapted to be fixed to the aircraft floor, mounting elements for securing the top of the material to the first track so as to be movable within the track, mounting elements for securing the bottom of the material to the second track so as to be movable within the track, a mounting device adapted to fix one side of the material to a first aircraft wall, a locking mechanism adapted to secure the other side of the material adjacent to a second aircraft wall and a drive mechanism for moving the second side of the material from a position adjacent the first aircraft wall to a position adjacent the second aircraft wall.

In accordance with specific aspects of this invention, the mounting device for fixing the one side of the material comprises a container for receiving the flexible sheet material when it is retracted. In addition, the drive mechanism comprises a motor driving a pulley mechanism for opening and retracting the curtain material. Retracting the curtain can be done by a spring-loaded vertical shaft that retracts the curtain material into the container. The curtain can further include an indicator mounted near the other leading side of the material to indicate that the curtain is about to close or retract, and a sensor mounted near the other side of the material to detect any obstruction to the movement of the curtain.

Other aspects and advantages of the invention, as well as the structure and operation of various embodiments of the invention, will become apparent to those ordinarily skilled in the art upon review of the following description of the invention in conjunction with the accompanying drawings.

### BRIEF DESCRIPTION OF THE DRAWINGS

The invention will be described with reference to the accompanying drawings, wherein:

FIG. 1 is a top isometric view of the isolation curtain located in an aircraft cabin in accordance with the present invention.

FIG. 2 is a front view of the isolation curtain;

FIG. 3 is a schematic view of the Crupax flight deck security system (FDSS) including the aircraft lavatory in accordance with the present invention;

FIG. 4 is a block diagram of the Crupax FDSS;

FIG. 5 is a schematic view of the Crupax flight deck security system (FDSS) excluding the lavatory;

FIG. 6a to 6d represent different curtain track configurations;

FIG. 7 illustrates a security level 2 flight deck entry process;

FIG. 8 illustrates a security level 2 flight deck entry process when the lavatory is in the secure zone;

FIG. 9 illustrates a security level 3 flight deck entry process;

FIG. 10 illustrates a security level 3 flight deck entry process when the lavatory is in the secure zone;

FIG. 11 illustrates flight deck entry process for a non-aircrew member;

FIG. 12 illustrates flight deck exit process for the pilot;

FIG. 13 illustrates flight deck exit process for the pilot using the. lavatory in the secure zone; and

FIG. 14 illustrates a system for acquiring and transferring aircrew biometric data.

### DETAILED DESCRIPTION OF THE INVENTION

The present invention is directed to increasing cockpit security in support of, and in conjunction with, the new FAA mandated bullet-proof cockpit door. This is accomplished by the Crupax Flight Deck Security System (FDSS), which provides a physical barrier that cannot be penetrated by unauthorized persons while the cockpit door is unlocked. Rather than use a second solid door, which is much too heavy and expensive to install in aircraft, Crupax FDSS incorporates a lightweight isolation curtain that keeps all intruders at a safe distance whenever the cockpit door is vulnerable. In using the term curtain, it is understood that it is meant to include any type of flexible barrier that can be rolled, folded or other such that it may be extended along tracks or guides to close an opening.

Crupax FDSS requires that all persons desiring cockpit entry must, in every case, be positively identified as bona fide aircrew members by an identification method, or alternatively by being personally known to the pilots, before they are able to gain entry to the cockpit. The pilots have full control of the system, and must approve each entry or exit operation. The pilots have system override capability, however they must be careful how they exercise that function as it may expose them to unseen dangers. Any circumvention of the system may be recorded for audit purposes, thereby preventing flight crews from becoming complacent or bypassing the system routinely.

Because of the many different aircraft types and models, Crupax FDSS may have different configurations incorporating varying levels of security for installation in different types of aircraft. For example, a small commuter aircraft with little passenger capacity and no flight attendants does not, in many cases, have even a basic cockpit door. The Crupax isolation curtain, manually or electrically operated, can fill this void very effectively. As well, a large cargo aircraft with no passenger seats can be outfitted with a similar isolation curtain system. Larger passenger aircraft, on the other hand, will require a much higher level of security having a motorized isolation curtain with video camera and biometric identification systems as methods of identification.

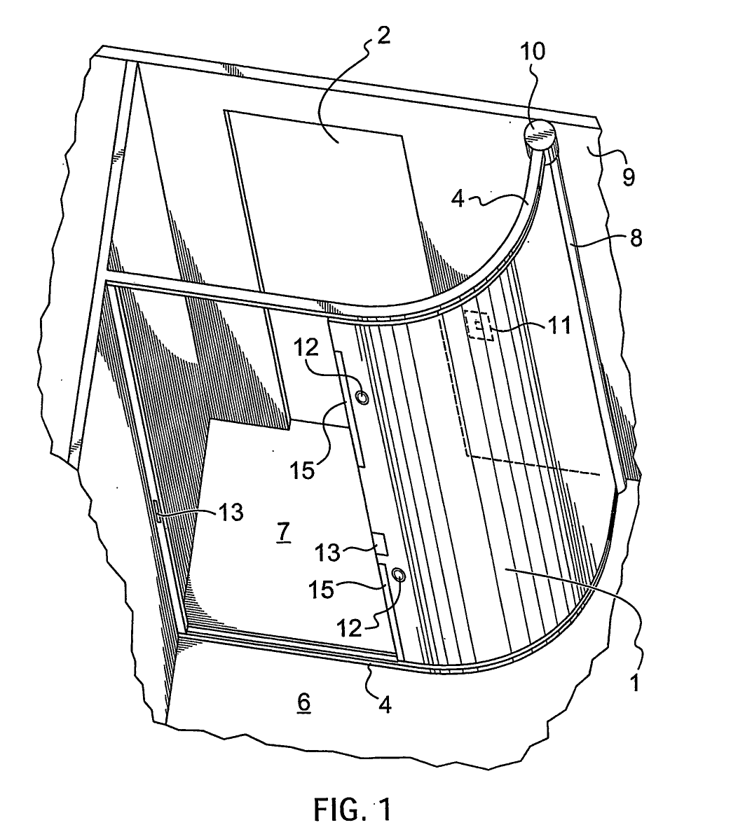

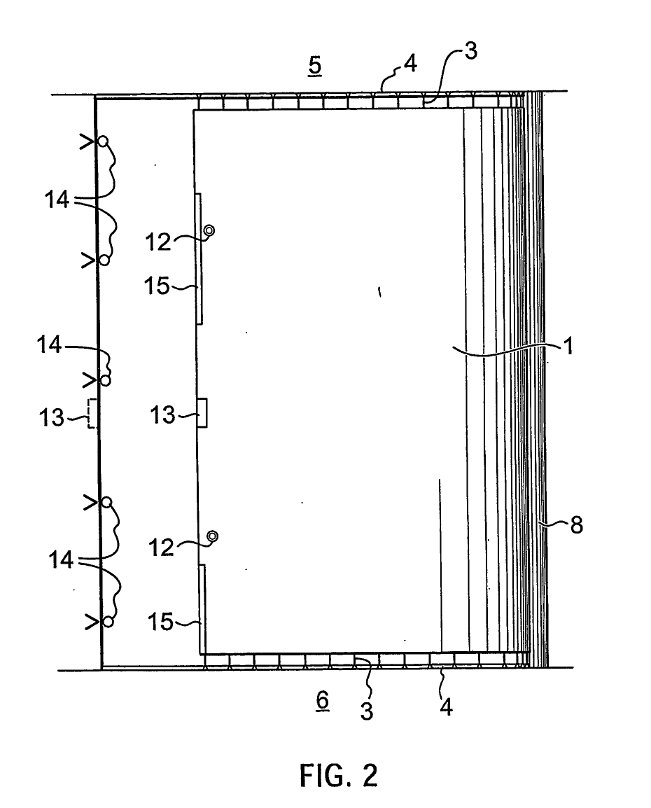

The basic component of the FDSS is a retractable flexible isolation curtain 1, illustrated schematically in FIGS. 1 and 2, that may be installed in existing aircraft or in new aircraft to provide a physical barrier to anyone trying to enter the flight deck of an aircraft whether the flight deck has a cockpit door 2 that is open, or only an opening 2a to the flight deck from the aircraft cabin. The retractable curtain 1 includes mounting elements 3 that movably connect the curtain 1 to tracks or guides 4 that are securely fixed to the aircraft cabin ceiling 5 and floor 6. The retractable isolation curtain 1 travels securely within the tracks 4 to form a secure zone 7 at the opening 2a to the flight deck or in front of the cockpit door 2. When the curtain 1 is closed, the mounting elements 3 prevent anyone from slipping underneath or reaching over the top of the curtain 1. When retracted, the isolation curtain 1 rolls or folds inside a container 8 such as a roll-up tube, which may be as small as 3″ in diameter depending on the thickness and materials used in the curtain 1. The container 8 is mounted vertically on the wall 9 outside the cockpit door 2. In aircraft having cockpit doors 2, it is preferred to have the curtain 1 tracks 4 fixed in the order of three feet from the cockpit door 2 to provide just enough space for a flight attendant carrying a tray to stand comfortably in the secure zone 7 between the curtain 1 and the cockpit door 2 while awaiting entry to the flight deck or exit from the secure zone 7.

The curtain 1 may be operated manually whereby a member of the aircrew may close and lock the curtain from the flight deck side of the curtain 1 using a manual locking mechanism. Alternately, the curtain may include a motor 10 located in the container 8 with a system for unrolling the curtain 1 from the container 8 and for retracting the curtain 1 back into the container 8. The curtain 1 locks in the closed position using an electrically controlled lock such as a number of solenoids 14. The controls 11 for closing and retracting the curtain 1 would be located on the wall 9 on either side of the cockpit door opening 2a on the flight deck side of the closed curtain 1. In either case, the security curtain 1 has a fail-safe feature allowing it to be opened manually from the flight deck side in case of equipment failure. The curtain 1, when not in use, retracts into container 8 so that it does not interfere with flight attendants working in the area outside the cockpit door 2 or will not needlessly take up space so as not to impede the entrance or exit of passengers from the aircraft.

The isolation curtain 1 is made from a mechanically strong security material which may include aramid fibres and which may be reinforced to prevent cutting or tearing. The reinforcement may be an embedded steel mesh, resulting in a strong, lightweight and yet flexible curtain 1. An example of such a material is described in the UK Patent Application No 0203151.6 filed on Feb. 11, 2002 by the Bradbury Group Ltd. and entitled “Improvements in or relating to Flexible Barriers”.

The security curtain 1 described above is attached to the tracks 4 in such a manner so as to allow sufficient air passage so that it will not be blown out by rapid cabin decompression. As a safety measure, one or more warning lights 12 may be situated on the leading edge of the curtain 1 or near the curtain 1 to alert flight attendants in the vicinity of its imminent deployment so that they do not accidentally collide with the curtain or hinder its operation. In motorized versions, the curtain 1 may also include a sensor 14 on the forward edge of the curtain 1 so that it will automatically retract when the leading edge contacts an obstruction, thereby preventing injury to anyone getting in the way. Further, the curtain 1 is installed so that it does not interfere with access to wall-mounted appliances when retracted.

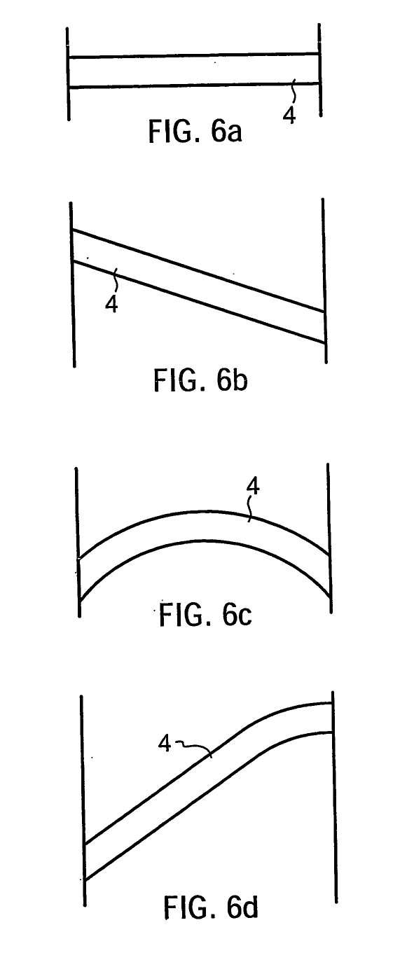

The curtain 1 location and configuration will vary with different aircraft designs so that the tracks or guides 4 may be straight across a hallway as shown in FIG. 6a, diagonal across a hallway as shown in FIG. 6b, curved across a hallway in front of the cockpit door opening 2a as shown in FIG. 6c or in some combination of the above as shown in FIG. 6d. Whatever the configuration, the isolation curtain 1, which travels in the tracks 4 seals off a secure zone 7 near the cockpit door 2 or opening 2a.

When extended, the curtain 1 will securely seal off a secure zone 7 immediately outside the cockpit door opening 2a. For aircraft without cockpit doors, the curtain 1 will secure the flight deck from intruders. For an aircraft with a cockpit door 2, an aircrew member wishing to enter the flight deck and standing in front of the cockpit door opening 2a need not worry about an intruder sneaking onto the flight deck or rushing the cockpit door 2 while it is open. The curtain 1 creates a secure zone 7 that allows the cockpit door 2 to be opened safely.

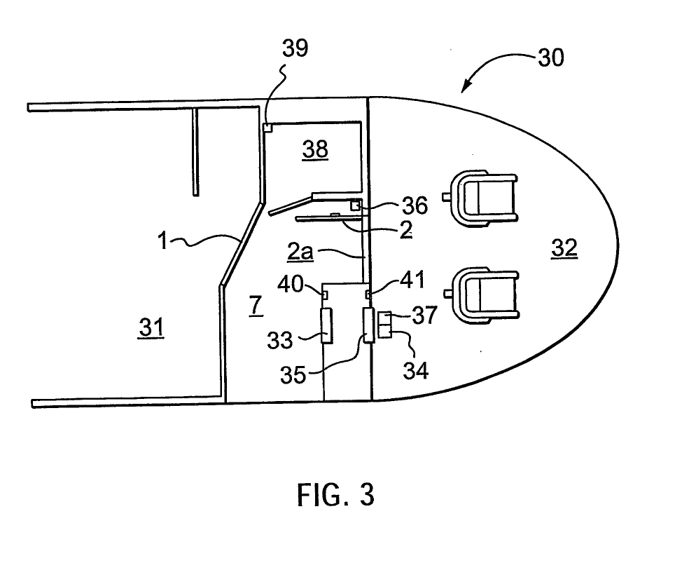

The Crupax Flight Deck Security System (FDSS) 30 will be described in conjunction with FIGS. 3, 4 and 5. The FDSS 30 comprises the isolation curtain 1 that is adapted to seal off a secure zone 7 in the aircraft cabin 31 next to the cockpit door 2 to the flight deck 32, an identity verification unit M 33 located within the secure zone 7 preferably just outside the cockpit door 2 and a computer controller 34 located on the flight deck 32.

The controller 34 senses the status of the lock on the cockpit door 2, and operates the isolation curtain 1 and the IU 33. An interface 37 is associated with the controller 34 on the flight deck 32 to permit the pilot to control the operation of the FDSS 30. Interface 37 may include control buttons and a keyboard for operating the system 30 and a speaker for giving warning signals to the pilot. The interface 37 control buttons may be located on a small control console where, for example, two function buttons are identified by different colors such as red and green, the red button for unlocking the cockpit door 2, while green button for closing and retracting the isolation curtain 1. The existing cockpit door lock unlocking control mechanism on an aircraft may be used as part of the red button control system. It is desirable to have the cockpit door 2 lock and the curtain control interlocked so that the pilot is warned not to unlock the cockpit door 2 when the curtain 1 is not fully closed and locked. This may be done electronically by an alarm buzzer or visually by having the red button lit when the cockpit door 2 is unlocked and the green button lit when the curtain is not closed and locked.

Once the cockpit door 2 is locked, the pilot is able to open the cockpit door 2 by unlocking it using the red button on the interface 37 or manually under emergency conditions, i.e. when the controller 34 is inoperative.

The curtain 1 is adapted to be normally retracted into the container 8 and out of the way when the cockpit door 2 is locked, but is further adapted to close and remain closed in certain predetermined situations so that no one outside of the flight deck 32 and particularly outside of the secure zone 7 is able to open it. The controller 34 further automatically operates the warning lights 12 when the isolation curtain 1 is about to close and automatically retracts the isolation curtain 1 when it contacts an obstruction while closing.

The controller 34, which is connected to the identity verification unit 33 by a hidden cable, receives the biometric data for the user of the identity verification unit 33. The data is compared to biometric data stored in the controller 34 to determine whether to close the isolation curtain 1. Further the isolation curtain 1 may be retracted through the controller 34 or manually from the flight deck side of the curtain 1. The identity verification unit 33 may be any of a number of biometric units that can determine the identity of a person by some unique physical characteristic of that person such as fingerprints, iris, DNA, facial recognition or other in order to uniquely and positively identify an individual.

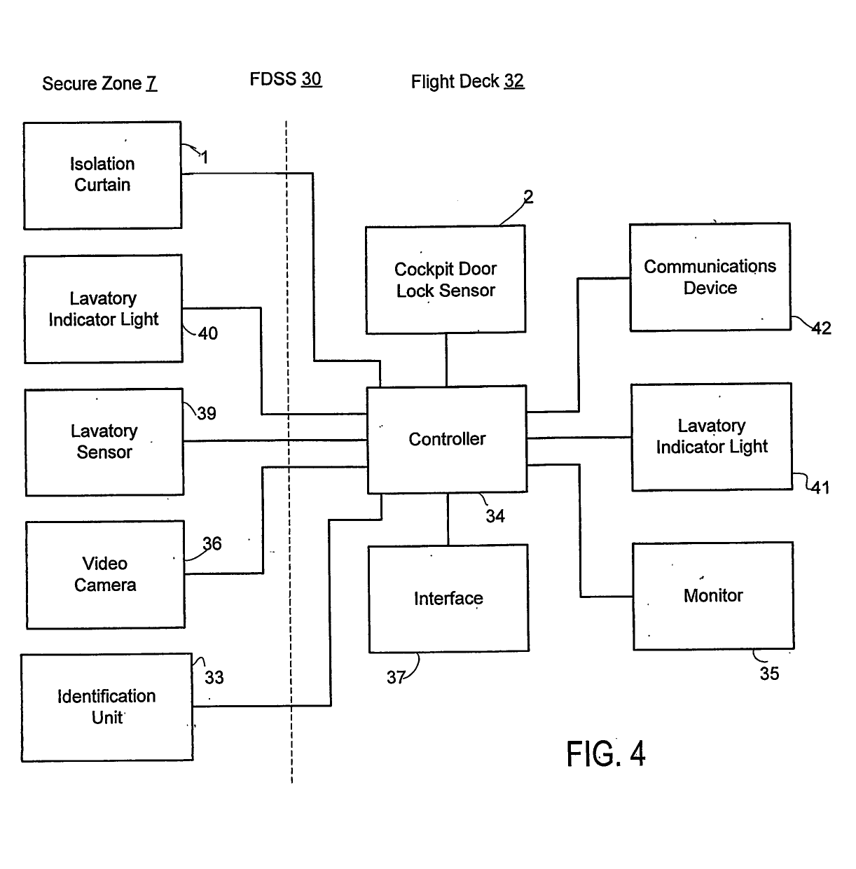

In addition, the controller 34 is linked to a communications device 42 for receiving biometric and other data either physically through discs or the like, or through a secure Internet link, as will be described below. As illustrated in FIGS. 3 and 4, the controller 34, the interface 37, the communications device 42 and the video monitor 35 are located on the flight deck 32, and may be mounted on the rear wall of the flight deck 32 of each aircraft or at some other appropriate location.

A video camera 36 is mounted in the area immediately outside the cockpit door 2 to provide the pilot with a clear view of the person who is requesting cockpit entry and is being identified by the identity verification unit 33, and to confirm that the person is alone in the secure zone 7 after the curtain 1 has closed. Live video from the camera 36 is displayed on a video monitor 35. The video camera system 35, 36 may operate independently from the controller 34. In aircraft designed in such a way that one camera 36 cannot give a satisfactory view of the whole secure zone 7 outside the cockpit door 2, one or more additional cameras may be required. In such a case, the video monitor 35 inside on the flight deck 32 will have a split screen to provide all views simultaneously.

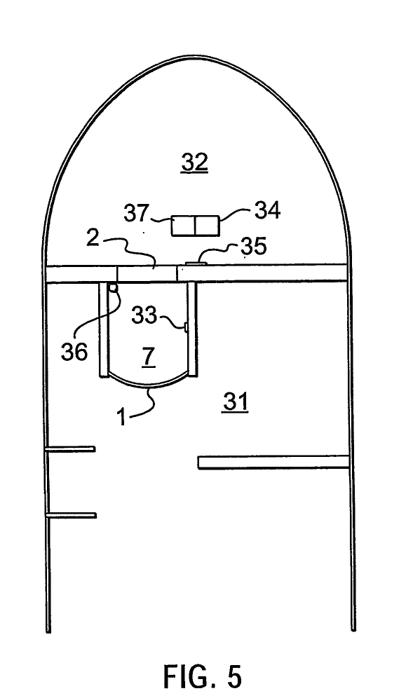

In the Crupax FDSS 30 illustrated in FIGS. 3 and 4, the lavatory 38 is within the secure zone 7 encompassed by the curtain 1 when it is closed, while the Crupax FDSS 30 in FIG. 5 does not have a lavatory 38 in the secure zone 7. When the lavatory 38 is in the secure zone 7, a lavatory occupancy sensor 39 is located in the lavatory 38 and is connected to two red flashing indicator lights 40, 41, which are activated when the presence of a person is sensed inside the lavatory 38. One of the indicator lights 40 is located on the hallway wall near identity verification unit 33 and the second light 41 is located near the video monitor screen 35 on the flight deck 32.

The lavatory sensor 39, flashing light 40, 41 system may be an independent stand alone system, which the pilot is required to monitor when someone is requesting entry onto the flight deck 32, however, it is preferred that the system be connected to the controller 34 to prevent any possible security breaches. For instance, an alarm buzzer may also be made to sound on the interface 37 and a large red “X” may be made to flash on the monitor screen 35 to warn the pilot against opening the cockpit door 2 if someone is requesting entry onto the flight deck 32 while a person is in the lavatory 38. In addition, the isolation curtain 1 may be programmed to be able to be retracted but will not close while the lavatory 38 is occupied, this being the only case in which the pilot does not have complete system override capability. This prevents an intruder from hiding undetected in the washroom while waiting for the cockpit door 2 to open. While a flight attendant is in the secure zone 7, an intruder cannot also be in the secure zone 7 without the attendant's knowledge, nor wait in the lavatory 38 for the cockpit door 2 to open without the pilot's knowledge.

The Flight Deck Security System 30 is always under the control of the pilot or other flight crew member on the flight deck 32. Once the flight crew has entered the aircraft flight deck 32, the pilot will activate the FDSS 30.

After the FDSS 30 is activated, an aircrew member wishing to enter the flight deck 32, must position him/herself in the secure zone 7 outside the cockpit door 2, where the IU 33 will determine his/her identity through biometric identification. When positive identification is made, the isolation curtain 1 closes automatically, creating the secure zone 7 between the curtain 1 and the cockpit door 2. Simultaneously, the interface 37 sounds a single chime on the flight deck 32, indicating to the pilot that a person who has been authenticated as a bona fide aircrew member, is awaiting entry. The pilot will then view the potential entrant on the monitor 35 to ensure the person is alone in the secure zone 7 and not under duress. Upon being satisfied that it is safe to do so, the pilot will unlock the cockpit door 2 by pressing the red button on the interface 37 console. The pilot has a manual override capability enabling him/her to unlock the cockpit door 2 and open the isolation curtain 1 simultaneously in an emergency by pressing simultaneously on the red and the green buttons on the interface 37 console, however this action will activate an alarm buzzer on the interface 37.

If verification fails, a series of two chimes alerts the pilot to a possible intrusion attempt and the isolation curtain 1 does not close. In such a case the controller 34 may store the biometric data obtained from the failed attempt for future investigation.

When a pilot wishes to exit the flight deck 32, he/she will first check the monitor 35 to ensure the secure zone 7 outside the cockpit door 2 is unoccupied, then using the interface 37, close the isolation curtain 1 by pressing the green button. He/she then checks the monitor 35 to ensure that the curtain 1 is closed and that the secure zone 7 is vacant, unlocks the cockpit door 2 by pressing the red button allowing the pilot to enter the secure zone 7. The cockpit door 2 is locked behind the pilot, after which the isolation curtain 1 opens automatically providing the pilot access to the aircraft cabin 31.

Pilots wishing to admit persons other than on-duty aircrew onto the flight deck 32 may do so by arranging via intercom for the visitor(s) to stand near the cockpit door 2, then closing the isolation curtain 1 by pressing the green button to establish the secure zone 7. The pilot then checks the video monitor 35 and unlocks the cockpit door 2 by pressing the red button. Pilots maintain full control over who enters the flight deck 32, thereby enabling them to interact with anyone on the aircraft if they feel safe in admitting that person(s). Visitors might include fellow airline employees, family or friends. Pilots can admit anyone they choose with no lapse in flight deck 32 security. They can also circumvent the FDSS 30 whenever they wish, but assume full responsibility for any risks incurred as a result. Pilots have total control and override capability of the system 30 with the exception noted above, but their actions may be recorded for future reference.

A door 2/curtain 1 interlock protocol in the controller 34 ensures that the cockpit door 2 and security curtain 1 are never open at the same time without the knowledge of the pilot, thereby making it physically impossible for aircrew to inadvertently leave the cockpit door 2 open to intruders. To unlock the door 2, the pilot must press the red button on the interface 37 console. If he/she pushes the red button before the isolation curtain 1 is securely locked, a large red “X” may be made to cover the monitor screen 35 and a loud alarm buzzer may be made to sound on the interface 37 speaker. The pilot may choose to ignore this warning and open the door 2 by pressing the red button again within a predetermined time if he/she wishes to exercise the system override capability in an emergency.

The controller 34 may further include a protocol by which all FDSS 30 activities during a flight are recorded. From the time of engine start-up until shutdown, each Crupax FDSS 30 action may be automatically recorded for future reference. This provides a check system so that airline companies can monitor how the system is being used, ensuring proper deployment of the system on all flights and providing an accurate record of events as they occur.

The Crupax FDSS 30 is designed with an open architecture that will allow for easy upgrade as new technologies become available. It will begin as a stand-alone system in each aircraft, but when secure Internet connection becomes a reality on aircraft, a simple upgrade will permit direct connection to the airline company's central computer so that the system can be used for aircrew scheduling and other administrative functions.

CRUPAX DFSS 30 provides airlines with a reliable method of physically limiting flight deck 32 access to authorized personnel only. The pilot may be required to activate the DFSS 30 or it may be activated automatically once the engines are started prior to a flight, after which all aircrew are, in every case, required to be positively identified by identity verification unit 33 before entering the flight deck 32. The system 30 serves to make the aircraft flight deck 32 inaccessible to hijackers, making the likelihood of criminal trespass extremely remote. It therefore increases flight crew security and enables pilots to prevent potential hijackers, as well as unruly passengers, from gaining access to the flight deck 32.

The CRUPAX Flight Deck Security System (FDSS) 30 in accordance with the present invention can provide various levels of security for crews on flight decls as determined by the general environment in which they are working. Airlines operating in certain countries -with specific types of aircraft will require a predetermined level of security. The FDSS 30 may be configured in several forms to provide different levels of security for different types of aircraft, which, as examples, will be described below as security levels 1, 2 and 3.

Security Level 1—For small shuttle/commuter aircraft not equipped with a cockpit door 2, it may be sufficient to install only a security curtain 1 that the pilots can close to protect themselves from physical attack. This embodiment would have a similar track 4 and curtain 1 assembly as described above. The curtain 1 could be opened and closed manually or electrically by a motor from the flight deck 32 side only. The curtain 1 may have a small viewing window or peephole so that pilots can see the cabin area 31 outside the curtain 1.

Security Level 2—For medium size commuter aircraft, it may be sufficient to combine the motorized security curtain I which assures a secure zone 7 at the cockpit door 2 with a video camera system 35, 36 which allows the pilot(s) to visually verify the identity of the person seeking entry onto the flight deck 32 as well as to determine that the person is alone in the secure zone 7 before unlocking the cockpit door 2. This security level must include a lavatory 38 occupancy sensor 39 if the lavatory 38 is located within the secure zone 7.

Level 2 security would be appropriate in situations where there are a small number of flight attendants who work with the pilots on a monthly rotation so that they are known to each other and biometric identification is not considered necessary.

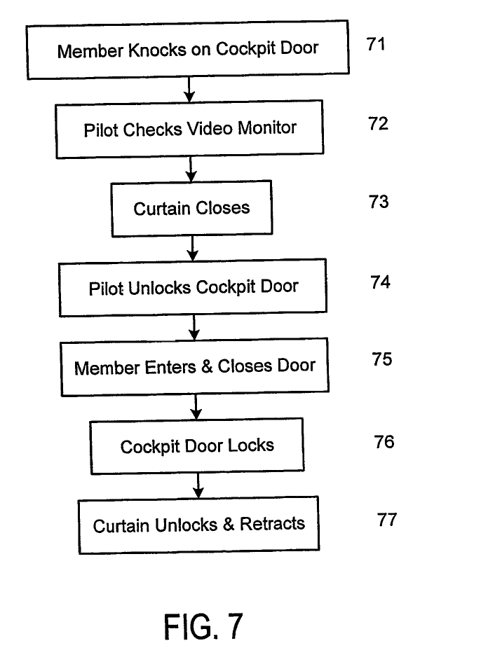

As shown in the flow diagram in FIG. 7, the process for an aircrew member to gain entry to the flight deck under security level 2 includes the following steps:
the member knocks on the cockpit door 2—71;
the pilot checks the video monitor to identify the aircrew member and to make sure the member is alone—72;
when satisfied, the pilot pushes the green button and watches the curtain 1 close and lock—73;
the pilot pushes the red button to unlock the cockpit door 2—74;
the member enters the flight deck and closes the cockpit door 2—75;
the cockpit door 2 locks—76;
the curtain 1 unlocks and retracts into the container 8—77.

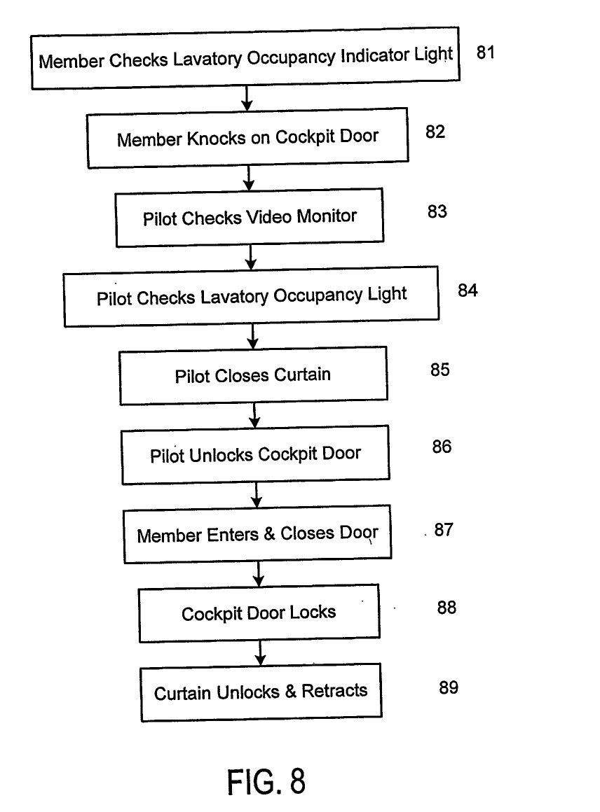

As shown in the flow diagram in FIG. 8, the process for an aircrew member to gain entry to the flight deck 32 under security level 2 when the lavatory 38 is within the secure zone 7 differs from the process in FIG. 7 and includes the following steps:
the aircrew member checks the lavatory 38 occupancy indicator light 40—81;
the member knocks on the cockpit door 2—82;
the pilot checks the video monitor to identify the aircrew member and to make sure the member is alone—83;
the pilot checks the lavatory occupancy light 41—84;
when satisfied, the pilot pushes the green button and watches the curtain 1 close and lock—85;
the pilot pushes the red button to unlock the cockpit door 2—86;
the member enters the flight deck and closes the cockpit door 2—87;
the cockpit door 2 locks—88;
the curtain 1 unlocks and retracts into the container 8—89.

Security Level 3—For larger aircraft where aircrew numbering ten or more are often unknown to each other, biometric identification of all aircrew members is crucial in order to avoid infiltration by impostors. This security level would use the entire Crupax FDSS 30 described above. A lavatory 38 occupancy sensor 39 would be required in aircraft that have a lavatory 38 located within the secure zone 7.

It should be noted that the Level 3 system does not require pilots to recognize the person requesting entry. In many cases the pilots do not know some or all of the flight attendants as they work with a different crew on almost every assignment, and in larger aircraft the crew may number fifteen or more. The pilots must have confidence in the system's ability to verify aircrew identity, and they must use the security camera 36 to establish that the person is alone and is not under duress or acting suspiciously. The video monitor 35 will clearly show the entire secure zone 7, and the pilots will decide from what they see whether it is safe to open the door 2. If in doubt, they may delay the opening and converse with flight attendants by intercom until satisfied that it is safe.

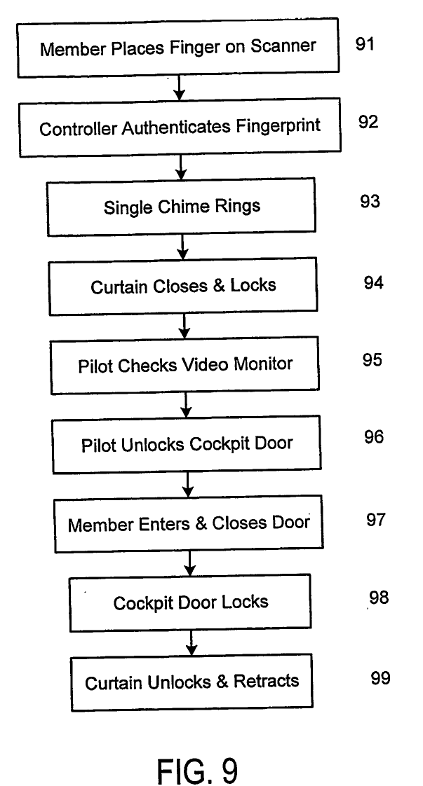

As shown in the flow diagram in FIG. 9, the process for an aircrew member to gain entry to the flight deck under security level 3 includes the following steps where the biometric identification unit is a fingerprint scanner:
the member places a finger on the fingerprint scanner 33—91;
the controller 34 authenticates the member's fingerprint—92;
a single chime rings on the interface 37—93;
the curtain 1 closes and locks—94;
the pilot checks the video monitor to make sure that the member is alone—95;
when satisfied, the pilot pushes the red button to unlock the cockpit door 2—96;
the member enters the flight deck and closes the cockpit door 2—97;
the cockpit door 2 locks—98;
the curtain 1 unlocks and retracts into the container 8—99.

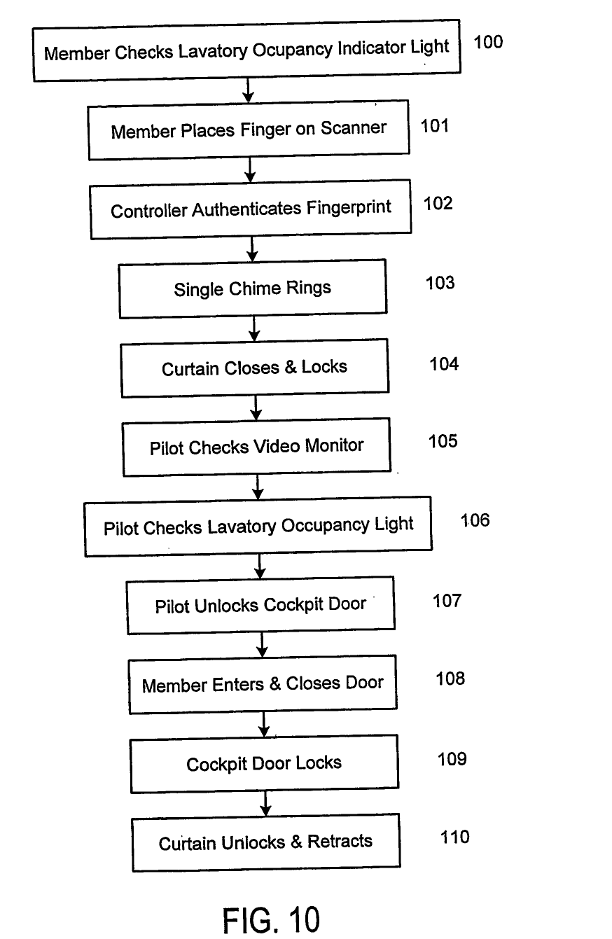

As shown in the flow diagram in FIG. 10, the process for an aircrew member to gain entry to the flight deck 32 under security level 3 when the lavatory 38 is within the secure zone 7 differs from the process in FIG. 9 and includes the following steps:
the aircrew member checks the lavatory 38 occupancy indicator light 40—100;
the member places a finger on the fingerprint scanner 33—101;
the controller 34 authenticates the member's fingerprint—102;
a single chime rings on the interface 37—103;
the curtain 1 closes and locks—104;
the pilot checks the video monitor to make sure that the member is alone—105;
the pilot checks the lavatory occupancy light 41—106;
when satisfied, the pilot pushes the red button to unlock the cockpit door 2—107;
the member enters the flight deck and closes the cockpit door 2—108;
the cockpit door 2 locks—109;
the curtain 1 unlocks and retracts into the container 8—110.

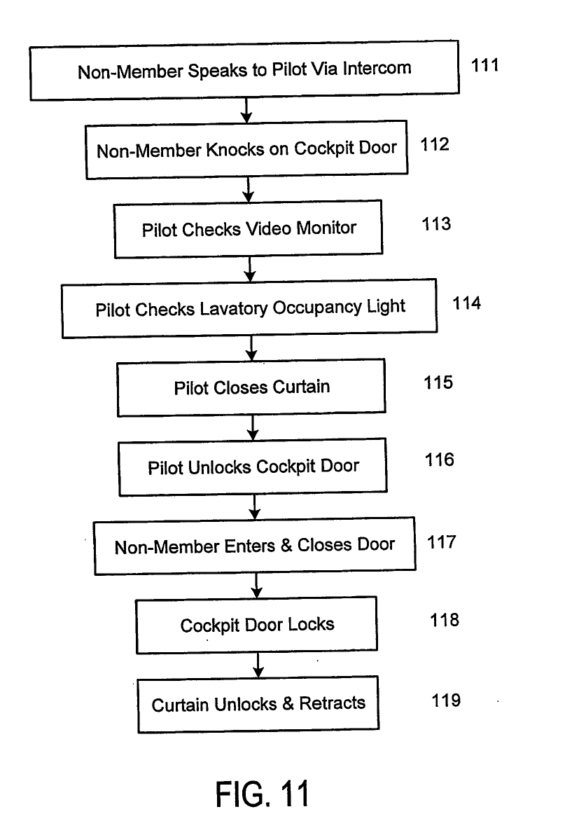

As shown in the flow diagram in FIG. 11, the process for a non-aircrew member to gain entry to the flight deck 32 under security level 2 or 3, when the lavatory 38 is within the secure zone 7, includes the following steps:
the non-aircrew member desiring entry seeks and receives permission to access the flight deck 32 from the pilot via the aircraft's intercom—111;
the non-aircrew member knocks on the cockpit door 2—112;
the pilot checks the video monitor to identify the non-aircrew member and to make sure that the non-aircrew member is alone—113;
the pilot checks the lavatory occupancy light 41—114;
when satisfied, the pilot pushes the green button and watches the curtain 1 close and lock—115;
the pilot pushes the red button to unlock the cockpit door 2—116;
the non-aircrew member enters the flight deck 32 and closes the cockpit door 2—117;
the cockpit door 2 locks—118;
the curtain 1 unlocks and retracts into the container 8—119.

Under security levels 2 and 3, one of the pilots may wish to leave the flight deck 32 either to go to the aircraft cabin 31 or to the lavatory 38. As well, after an attendant or other person has completed their task or visit to the flight deck, they must be able to leave the flight deck without a breach in security. The processes for leaving the flight deck will be described with respect to a pilot leaving the flight deck, but applies to all others, and in relation to the configuration where the lavatory 38 is within the secure zone 7.

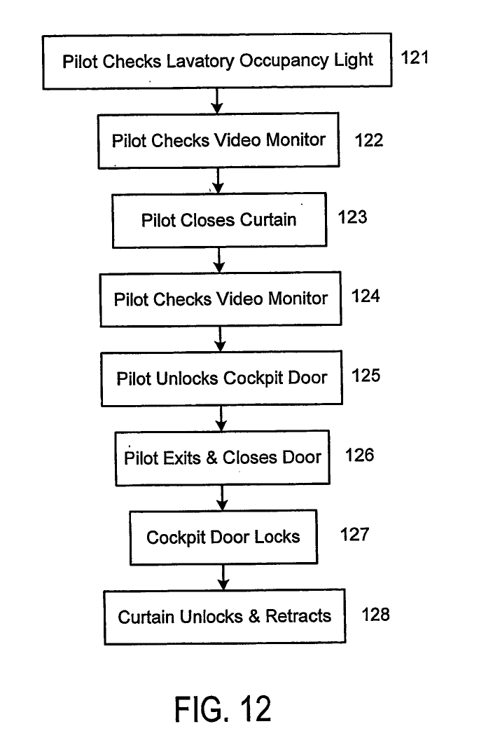

As shown in the flow diagram in FIG. 12, the process for a pilot to exit the flight deck 32 includes the following steps:
the pilot checks the lavatory occupancy light 41—121;
the pilot views the video monitor to ensure that the area outside the cockpit door 2 is clear—122;
when satisfied, the pilot pushes the green button and watches the curtain 1 close and lock—123;
the pilot again views the video monitor to ensure that the secure area 7 is unoccupied—124;
the pilot pushes the red button to unlock the cockpit door 2—125;
the pilot exits the flight deck and closes the cockpit door 2—126;
the cockpit door 2 locks—127;
the curtain 1 unlocks and retracts into the container 8—128.
   Steps 121 and 122 could be interchanged depending on the preference of the pilot.

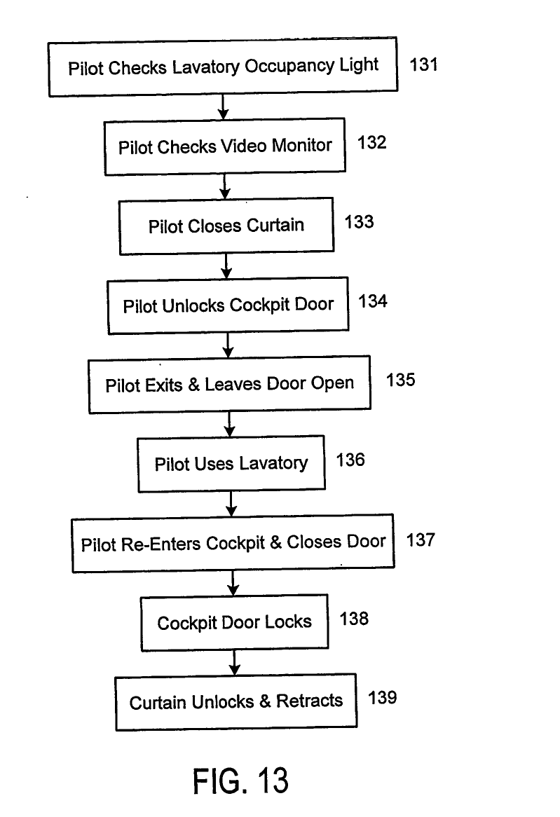

When the pilot wishes to use the lavatory 38 located in the secure zone 7, the process illustrated with respect to the flow diagram in FIG. 13 may be used; it includes the following steps:
the pilot checks the lavatory occupancy light 41—130;
the pilot views the video monitor to ensure that the area outside the cockpit door 2 is clear—131
when satisfied, the pilot pushes the green button and watches the curtain 1 close and lock—132;
the pilot again views the video monitor to ensure that the secure area 7 is. unoccupied—133;
the pilot pushes the red button to unlock the cockpit door 2—134;
the pilot exits the flight deck and leaves the cockpit door 2 open—135;
the pilot uses the lavatory 38—136;
the pilot re-enters the flight deck 32 and closes the cockpit door 2—137
the cockpit door 2 locks—138;
the curtain 1 unlocks and retracts into the container 8—139.

Steps 121 and 122 in FIG. 12 as well as steps 130 and 131 in FIG. 13 may be interchanged.

The installation of a Crupax FDSS 30 on an aircraft can further provide the advantage of enhancing other security concerns on an aircraft. For instance, most commercial passenger aircraft have one or more doors/hatches that provide access to under-floor electronic bays or the cargo hold. These are usually located in the floor near the front of the cabin. An intruder may attempt to access these areas to damage the hydraulics, fuel lines, electronics or other vital components. These doors or hatches may be fitted with electronic locks which are connected into the Crupax FDSS 30 and can only be opened during a flight by one of the pilots after he/she has been positively identified by the identity verification unit 33.

Further, an additional IU 33 and security curtain 1 may be located at the entrance to the aircrew sleeping quarters. Most of the larger craft designed for lengthy intercontinental flights have aircrew rest areas where passengers are not permitted, however there is nothing to bar their entry. The additional IU 33 and security curtain 1, connected to the Crupax FDSS 30 controller could serve to provide the aircrew security and privacy while resting, as well as a safe refuge if one is needed.

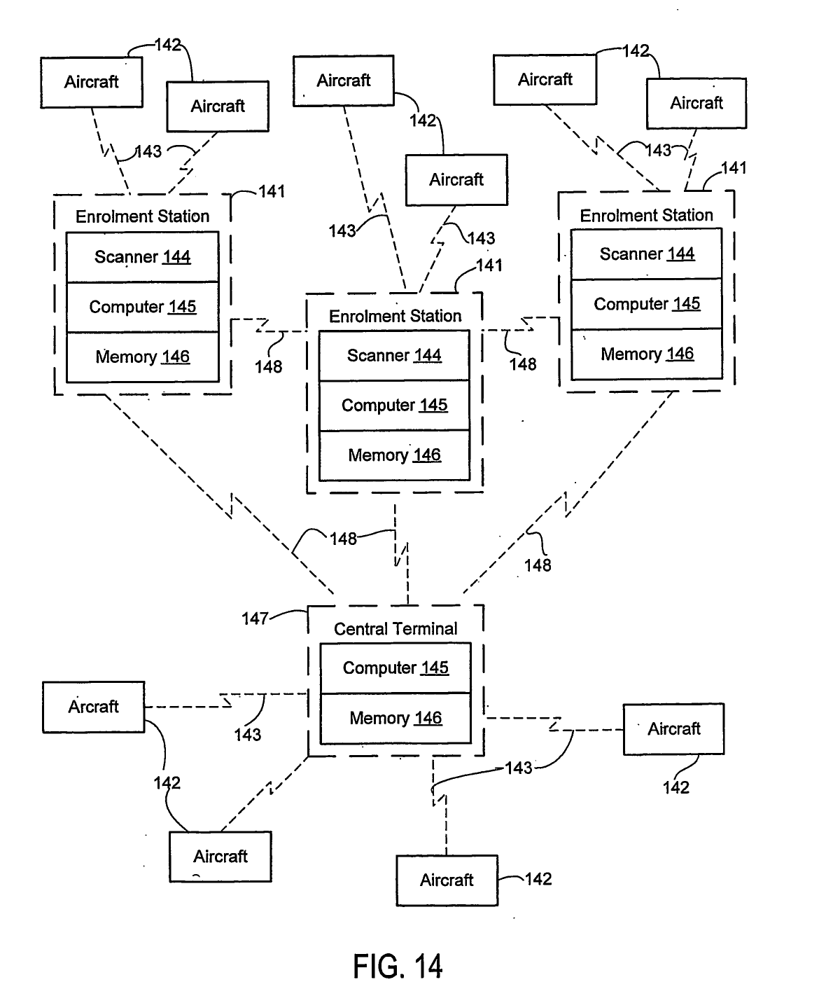

As described above, the Crupax FDSS 30 includes a controller 34 for determining if access to the flight deck 32 is to be provided to a person based on a biometric scan of the person seeking access. Biometric data for the person seeking access acquired at the identity verification unit 33 is transferred to the controller 34 where it is compared to biometric data for aircrew to determine if the person can be given access to the flight deck 32. FIG. 14 schematically illustrates a system 140 for acquiring and distributing the biometric data for aircrew. The system 140 includes a number of enrollment stations 141 where each aircrew member provides a scan of an identifying characteristic, such as a fingerprint, that is to be used in the, Crupax FDSS 30. Each enrollment station 141 for acquiring biometric data includes an identifying characteristic scanner 144, such as a fingerprint scanner, a computer terminal 145 for controlling the scanner 144 and a high security memory 146 for storing the biometric data obtained from the scanner 144. An enrollment station 141 may be located in each airline crew base with a central computer terminal 147 at the corporate head office. In the case of Air Canada, the enrollment station 141 locations would be in Halifax, Montreal, Toronto, Winnipeg, Calgary and Vancouver, with the central terminal 147 situated in Montreal. In each office where aircrew are hired or terminated, an IU enrollment station 141 would be used to fingerprint each employee to obtain the biometric data, which would then be stored on the computer memory 146. All enrollment stations 141 and the central terminal 147 may be linked to each other by a secure communications network 148 to facilitate inter-station data transfer. The enrollment station computer 141 as well as the central terminal 147 will have a memory 146 with sufficient capacity to store all biometric data for the airline's complete aircrew work force.

The biometric data which is stored at the enrollment station 141 and the central terminal 147 is transferred, in whole or in part, either physically, as by a CD, or electronically by secure Internet communications 143 to the Crupax FDSS 30 in each of the aircraft 142 in the fleet. The transfer is accomplished through the use of the communications device 42 in FDSS 30. In aircraft 142 that do not have a secure Internet communications link, the transfer will be made physically to the aircraft 142 in the area of the enrolment station 141. In the case of retrofit installations, a designated employee in each crew base will, on a regular schedule, interrogate the enrollment station 141 memory 146 and obtain an “update” CD, smart card or USB pen drive containing any changes to aircrew data that have occurred since the last update. This data is then downloaded to each aircraft controller 34 through the communications device 42. This will ensure that data on all new hires, terminations and other changes are provided to each controller 34 in a timely fashion to enable recognition of new employees and rejection of those terminated.

With the introduction of secure Internet communications in new aircraft being built, the central data terminal 147 may automatically download aircrew scheduling information plus biometric data for only those aircrew members working on that particular flight prior to commencement of each leg of the flight. When the controller 34 compares the scanned biometric data to the stored biometric data it will only have the biometric data for the scheduled crewmembers to check, enabling it to respond to a query instantly.

The Crupax system as described above has many advantages. For example, it
1) Secures the flight deck continuously for the duration of a flight.
2) Positively identifies all flight crew members before they enter the flight deck.
3) Physically bars cockpit entry to all unauthorized personnel.
4) Provides flight crew with easy, secure access to cockpit (user friendly).
   On the other hand, the system does not:
1) Permit flight crews to circumvent the system undetected.
2) Allow cockpits to be open or easily accessible at any time.
3) Unduly retard crew efficiency.

While the invention has been described according to what is presently considered to be the most practical and preferred embodiments, it must be understood that the invention is not limited to the disclosed embodiments. Those ordinarily skilled in the art will understand that various modifications and equivalent structures and functions may be made without departing from the spirit and scope of the invention as defined in the claims. Therefore, the invention as defined in the claims must be accorded the broadest possible interpretation so as to encompass all such modifications and equivalent structures and functions.

1. A flight deck security system for an aircraft comprising:
a secure closable isolation curtain mounted in the aircraft cabin to form a barrier for entry to the flight deck;
means for viewing a zone in the aircraft adjacent to the isolation curtain; and
means for closing and retracting the isolation curtain.

2. A flight deck security system for an aircraft as claimed in claim 1 wherein the viewing means comprises an opening in the isolation curtain.

3. A flight deck security system for an aircraft as claimed in claim 1 wherein the viewing means comprises a video camera in the aircraft cabin and a video monitor on the flight deck.

4. A flight deck security system for an aircraft as claimed in claim 1, which further includes means for manually closing and retracting the curtain.

5. A flight deck security system for an aircraft as claimed in claim 1 which further comprises motor means coupled to the isolation curtain for driving the curtain closed.

6. A flight deck security system for an aircraft as claimed in claim 5, which further comprises a spring loaded mechanism for retracting the closed curtain.

7. A flight deck security system for an aircraft as claimed in claim 1, which further includes means for locking the closed curtain from the flight deck side.

8. A flight deck security system for an aircraft comprising:
a secure closable isolation curtain adapted to be mounted in the aircraft cabin to form a secure zone outside of a lockable cockpit door to the flight deck;
means for viewing the secure zone from the flight deck; and
controller means on the flight deck having means for controlling the operation of the isolation curtain.

9. A flight deck security system for an aircraft as claimed in claim 8 wherein the viewing means comprises a video camera in the aircraft and a video monitor on the flight deck.

10. A flight deck security system for an aircraft as claimed in claim 8, which further comprises means for identifying a person located in the secure zone.

11. A flight deck security system for an aircraft as claimed in claim 10 wherein the person identifying means comprises a biometric identification unit adapted to be mounted in the secure zone.

12. A flight deck security system for an aircraft as claimed in claim 11 wherein the biometric identification unit includes a fingerprint scanner.

13. A flight deck security system for an aircraft as claimed in claim 12 wherein the fingerprint scanner is coupled to the controller means.

14. A flight deck security system for an aircraft as claimed in claim 8 wherein the controller means includes means for sensing the status of the lockable cockpit door.

15. A flight deck security system for an aircraft as claimed in claim 14 wherein the controller means comprises means for causing the cockpit door to unlock.

16. A flight deck security system for an aircraft as claimed in claim 8, which further includes means for sensing the presence of a person in a lavatory opening into the secure zone.

17. A flight deck security system for an aircraft as claimed in claim 16, which further includes means adapted to be located in the secure zone and the flight deck for indicating the presence of a person in the lavatory.

18. A flight deck security system for an aircraft as claimed in claim 16 wherein the lavatory sensing means is coupled to the controller means.

19. A flight deck security system for an aircraft as claimed in claim 8, which further comprises motor means coupled to the isolation curtain for driving the curtain.

20. A flight deck security system for an aircraft as claimed in claim 19, which further comprises a spring loaded mechanism for retracting the closed curtain.

21. A flight deck security system for an aircraft as claimed in claim 19 wherein the controller comprises means for operating the motor means.

22. A flight deck security system for an aircraft as claimed in claim 19, which further comprises lights mounted on or near the isolation curtain for indicating that the curtain is closing or retracting.

23. A flight deck security system for an aircraft as claimed in claim 19, which further comprises means coupled to the controller means and positioned on a leading edge of the isolation curtain to detect an obstruction to the closing of the curtain.

24. A flight deck security system for an aircraft as claimed in claim 8, which further comprises means coupled to the controller means for locking the isolation curtain in a closed position.

25. A flight deck security system for an aircraft comprising:
a secure closable isolation curtain mounted in the aircraft cabin to form a secure zone outside of a lockable cockpit door to the flight deck;
means for identifying a person located in the secure zone; and
controller means on the flight deck for controlling the operation of the isolation curtain.

26. A flight deck security system for an aircraft as claimed in claim 25 wherein the person identifying means comprises a biometric identification unit adapted to be mounted in the secure zone.

27. A flight deck security system for an aircraft as claimed in claim 26 wherein the biometric identification unit is a fingerprint scanner.

28. A flight deck security system for an aircraft as claimed in claim 27 wherein the fingerprint scanner is coupled to the controller means.

29. A flight deck security system for an aircraft as claimed in claim 25 wherein the controller means includes means for sensing the status of the lockable cockpit door.

30. A flight deck security system for an aircraft as claimed in claim 29 wherein the controller means comprises means for causing the cockpit door to unlock.

31. A flight deck security system for an aircraft as claimed in claim 25, which further comprises motor means coupled to the isolation curtain for driving the curtain.

32. A flight deck security system for an aircraft as claimed in claim 31 wherein the controller comprises means for operating the motor means.

33. A flight deck security system for an aircraft as claimed in claim 32, which further comprises means coupled to the controller means for locking the isolation curtain in a closed position.

34. A flight deck security system for an aircraft as claimed in claim 25, which further includes means for sensing the presence of a person in a lavatory opening into the secure zone.

35. A process under the control of a pilot for permitting entry to an aircraft flight deck where the aircraft has a lockable cockpit door to the flight deck and a lockable isolation curtain mounted to provide a secure zone in the aircraft cabin adjacent the cockpit door, comprising the steps:
a. receiving an indication of a person's desire to enter the flight deck;
b. verifying that the person is alone in the secure zone;
c. closing the isolation curtain;
d. unlocking the cockpit door;
e. allowing the person to enter the flight deck; and
f. closing and locking the cockpit door.

36. A process as claimed in claim 35 which further includes the step:
g. retracting the curtain.

37. A process as claimed in claim 36, wherein step b. includes checking occupancy of a lavatory opening to the secure zone.

38. A process as claimed in claim 36 wherein step c. includes locking the closed curtain and step g. includes unlocking the curtain.

39. A process under the control of a pilot for permitting aircrew entry to an aircraft flight deck where the aircraft has a lockable cockpit door to the flight deck and a lockable isolation curtain mounted to provide a secure zone in the aircraft cabin adjacent the cockpit door, comprising the steps:
a. receiving confinnation that a person seeking entry is a member of the aircrew;
b. closing the isolation curtain;
c. verifying that the person is alone in the secure zone;
d. unlocking the cockpit door;
e. allowing the-aircrew member to enter the flight deck; and
f. closing and locking the cockpit door.

40. A process as claimed in claim 39 which further includes the step:
g. retracting the curtain.

41. A process as claimed in claim 40, wherein step c. includes checking occupancy of a lavatory opening to the secure zone.

42. A process as claimed in claim 40 wherein step b. includes locking the closed curtain and step g. includes unlocking the curtain.

43. A process as claimed in claim 40 wherein step a. includes:
a.1. verifying a biometric characteristic of the person seeking entry; and
a2. comparing the biometric characteristic to the biometric characteristics of the aircrew.

44. A process as claimed in claim 43 wherein the biometric characteristic is a fingerprint.

45. A process under the control of a pilot for exiting an aircraft flight deck where the aircraft has a lockable cockpit door to the flight deck and a lockable isolation curtain mounted to provide a secure zone in the aircraft cabin adjacent the cockpit door, comprising the steps:
a. closing and locking the isolation curtain;
b. verifying that no one is in the secure zone;
c. unlocking the cockpit door;
d. exiting flight deck;
e. closing and locking the cockpit door.

46. A process as claimed in claim 45 which further includes the step:
f. unlocking and retracting the curtain.

47. A process as claimed in claim 46 wherein step a. includes checking occupancy of a lavatory opening to the secure zone.

48. A process as claimed in claim 45 wherein step d. includes:
d.1. entering the lavatory;
d.2. exiting the lavatory; and
d.3. entering the flight deck.

49. A process as claimed in claim 48 which further includes the step:
f. unlocking and retracting the curtain.

50. A system under the control of a pilot for permitting entry to an aircraft flight deck where the aircraft has a lockable cockpit door to the flight deck and a lockable isolation curtain mounted to provide a secure zone in the aircraft cabin adjacent the cockpit door, comprising the steps:
means for receiving an indication of a person's desire to enter the flight deck;
means for verifying that the person is alone in the secure zone;
means for closing the isolation curtain;
means for unlocking the cockpit door to allow the person to enter the flight deck; and
means for closing and locking the cockpit door.

51. A system as claimed in claim 50, which further includes means for retracting the curtain.

52. A system as claimed in claim 51, which further includes means for checking occupancy of a lavatory opening to the secure zone.

53. A system as claimed in claim 51, which further includes means for locking and unlocking the closed curtain.

54. A system under the control of a pilot for permitting aircrew entry to an aircraft flight deck where the aircraft has a lockable cockpit door to the flight deck and a lockable isolation curtain mounted to provide a secure zone in the aircraft cabin adjacent the cockpit door, comprising:
means for providing the pilot confirmation that a person seeking entry is a member of the aircrew;
means for closing the isolation curtain;
means for verifying that the person is alone in the secure zone;
means for unlocking the cockpit door to allow the aircrew member to enter the flight deck; and
means for closing and locking the cockpit door.

55. A system as claimed in claim 54, which further includes means for retracting the curtain.

56. A system as claimed in claim 55, which further includes means for checking occupancy of a lavatory opening to the secure zone.

57. A system as claimed in claim 55, which further includes means for locking and unlocking the closed curtain.

58. A system as claimed in claim 55, which further includes means for verifying a biometric characteristic of the person seeking entry and means for comparing the biometric characteristic to the biometric characteristics of the aircrew.

59. A system as claimed in claim 58 wherein the biometric characteristic is a fingerprint.

60. A system under the control of a pilot for a person to exit an aircraft flight deck where the aircraft has a lockable cockpit door to the flight deck and a lockable isolation curtain mounted to provide a secure zone in the aircraft cabin adjacent the cockpit door, comprising:
means for closing and locking the isolation curtain;
means for verifying that no one is in the secure zone;
means for unlocking the cockpit door for the person to exit the flight deck;
means for closing and locking the cockpit door.

61. A system as claimed in claim 60, which further includes means for unlocking and retracting the curtain.

62. A system as claimed in claim 61, which further includes means for checking occupancy of a lavatory opening to the secure zone.

63. A secure isolation curtain for an aircraft comprising:
flexible mechanically strong sheet material having a top, a bottom and two sides;
first track means adapted to be fixed to the aircraft ceiling;
second track means adapted to be fixed to the aircraft floor;
means securing the top of the material to the first track means so as to be movable within the track;
means for securing the bottom of the material to the second track means so as to be movable within the track;
means adapted to fix one side of the material to a first aircraft wall;
means adapted to secure the other side of the material adjacent to a second aircraft wall; and
means for moving the second side of the material from a position adjacent the first aircraft wall to a position adjacent the second aircraft wall.

64. A secure isolation curtain for an aircraft as claimed in claim 63 wherein the means for fixing the one side of the material comprises a container for receiving the flexible sheet material when it is retracted.

65. A secure isolation curtain for an aircraft as claimed in claim 63 wherein the moving means comprises a handle for manually closing and retracting the curtain material.

66. A secure isolation curtain for an aircraft as claimed in claim 63 wherein the moving means comprises a motor for driving a pulley mechanism for opening and retracting the curtain material.

67. A secure isolation curtain for an aircraft as claimed in claim 64 wherein the moving means comprises a spring-loaded vertical shaft for retracting the curtain material into the container.

68. A secure isolation curtain for an aircraft as claimed in claim 63, which further includes means for locking the other side of the material to the second aircraft wall.

69. A secure isolation curtain for an aircraft as claimed in claim 63, which further includes indicator means mounted near the other side of the material to indicate that the curtain is about to close.

70. A secure isolation curtain for an aircraft as claimed in claim 63, which further includes sensor means mounted near the other leading side of the material to detect an obstruction to the movement of the curtain.

71. A secure isolation curtain for an aircraft as claimed in claim 63, which further includes a controller for controlling the operation of the curtain.
